(19) United States
(12) Patent Application Publication
(10) Pub. No.: US 2012/0242691 A1
(43) Pub. Date: Sep. 27, 2012

(54) IMAGE FORMING APPARATUS, DISPLAY METHOD, AND NON-TRANSITORY COMPUTER-READABLE RECORDING MEDIUM ENCODED WITH DISPLAY PROGRAM

(75) Inventors: Yusaku Tanaka, Toyokawa-shi (JP); Tomokazu Kato, Toyokawa-shi (JP); Yoichi Kurumasa, Toyokawa-shi (JP); Hiroshi Sugiura, Toyokawa-shi (JP); Yoshiyuki Tamai, Toyohashi-shi (JP)

(73) Assignee: Konica Minolta Business Technologies, Inc., Tokyo (JP)

(21) Appl. No.: 13/427,398

(22) Filed: Mar. 22, 2012

(30) Foreign Application Priority Data
Mar. 24, 2011 (JP) 2011-066330

(51) Int. Cl. G09G 5/00

(52) U.S. Cl. 345/629

(57) ABSTRACT

An image forming apparatus includes a position detecting portion to detect a position designated by a user on a display surface of a display portion, a first display controlling portion to cause the display portion to display a first screen, a position check image displaying portion, responsive to detection of a position within a designation button on the first screen, to cause the display portion to display a position check image identical in shape and size to a second screen, a moving portion to move the position check image in the first screen, a position finalizing portion to finalize a position for displaying the second screen on the basis of the position of the position check image in the first screen, and a second display controlling portion to cause the display portion to display the second screen at the finalized position, to be overlaid on the first screen.

This application is based on Japanese Patent Application No. 2011-066330 filed with Japan Patent Office on Mar. 24, 2011, the entire content of which is hereby incorporated by reference.

### BACKGROUND OF THE INVENTION

1. Field of the Invention

The present invention relates to an image forming apparatus, a display method, and a non-transitory computer-readable recording medium encoded with a display program. More particularly, the present invention relates to an image forming apparatus which performs processing in accordance with setting values, a display method executed by the image forming apparatus, and a non-transitory computer-readable recording medium encoded with a display program for causing a computer to execute the display method.

2. Description of the Related Art

Recently, the functions included in a multi-function peripheral (MFP) have increased in complexity. In order to operate such an MFP, an increased number of items of processing conditions are needed for determining the MFP's operations, causing an increased number of items of processing conditions to be set on a single operation screen. This means that items have to be selected on a single operation screen and then setting values have to be set therefor. To this end, there is known a technique of displaying a soft keyboard, in addition to and on top of an operation screen, for use in setting a setting value. For example, Japanese Patent Application Laid-Open No. 2007-183787 discloses a software keyboard display device that includes a display screen, display information displayed on the display screen, and a software keyboard, displayed on the display screen, in which predetermined specific information is entered as a specific position on the display is touched. The software keyboard has two types of display: opaque display by which the display information is hidden; and semitransparent display by which the display information is visible through and together with the software keyboard.

With a semitransparent software keyboard, however, it is difficult to identify respective keys in the keyboard. With an opaque software keyboard, display information as the background is hidden thereunder, hindering recognition thereof.

### SUMMARY OF THE INVENTION

An aspect of the present invention provides an image forming apparatus which includes: a display portion to display an image; a position detecting portion to detect a position designated by a user on a display surface of the display portion; a first display controlling portion to cause the display portion to display a first screen; a position check image displaying portion operable, in response to detection of a position within a designation button on the first screen by the position detecting portion while the first screen is being displayed, to cause the display portion to display a position check image, the position check image being identical in shape and size to a second screen that is associated with the designation button, the position check image being displayed overlaid on the first screen in the state where an image of the first screen is visible through the position check image overlaid thereon; a moving portion to move the position check image in the first screen; a position finalizing portion to finalize a position for displaying the second screen in the first screen, on the basis of the position of the position check image in the first screen; and a second display controlling portion to cause the display portion to display the second screen at the position in the first screen that is finalized by the position finalizing portion, the second screen being displayed overlaid on the first screen which is being displayed on the display portion.

Another aspect of the present invention provides a display method performed by an image forming apparatus having a display portion to display an image, wherein the method includes: a position detecting step of detecting a position designated by a user on a display surface of the display portion; a first display controlling step of displaying a first screen on the display portion; a position check image displaying step of, in response to detection of a position within a designation button on the first screen in the position detecting step while the first screen is being displayed, displaying a position check image on the display portion, the position check image being identical in shape and size to a second screen that is associated with the designation button, the position check image being displayed overlaid on the first screen in the state where an image of the first screen is visible through the position check image overlaid thereon; a moving step of moving the position check image in the first screen; a position finalizing step of finalizing a position for displaying the second screen in the first screen, on the basis of the position of the position check image in the first screen; and a second display controlling step of displaying, on the display portion, the second screen at the position in the first screen that is finalized in the position finalizing step, the second screen being displayed overlaid on the first screen which is being displayed on the display portion.

A further aspect of the present invention provides a non-transitory computer-readable recording medium encoded with a display program performed by a computer which controls an image forming apparatus, the image forming apparatus having a display portion to display an image, wherein the program causes the computer to perform: a position detecting step of detecting a position designated by a user on a display surface of the display portion; a first display controlling step of displaying a first screen on the display portion; a position check image displaying step of, in response to detection of a position within a designation button on the first screen in the position detecting step while the first screen is being displayed, displaying a position check image on the display portion, the position check image being identical in shape and size to a second screen that is associated with the designation button, the position check image being displayed overlaid on the first screen in the state where an image of the first screen is visible through the position check image overlaid thereon; a moving step of moving the position check image in the first screen; a position finalizing step of finalizing a position for displaying the second screen in the first screen, on the basis of the position of the position check image in the first screen; and a second display controlling step of displaying, on the display portion, the second screen at the position in the first screen that is finalized in the position finalizing step, the second screen being displayed overlaid on the first screen which is being displayed on the display portion.

The foregoing and other features, aspects, and advantages of the present invention will become more apparent from the following detailed description of the present invention when taken in conjunction with the accompanying drawings.

### BRIEF DESCRIPTION OF THE DRAWINGS

FIG. 1 is a perspective view of an MFP according to an embodiment of the present invention;

FIG. 2 is a block diagram schematically showing the hardware configuration of the MFP;

FIG. 3 is a block diagram showing, by way of example, the functions of a CPU included in the MFP;

FIG. 4 shows an example of a first screen;

FIGS. 5A to 5C show exemplary displays when an item button is designated;

FIGS. 6A to 6C show a first set of exemplary displays when a transition button is designated;

FIGS. 7A and 7B show a second set of exemplary displays when a transition button is designated;

FIGS. 8 and 9 show a flowchart illustrating an example of the flow of a screen display control process;

FIG. 10 is a block diagram showing, by way of example, the functions of a CPU included in the MFP according to a modification; and

FIGS. 11 and 12 show a flowchart illustrating an example of the flow of the screen display control process according to the modification.

### DESCRIPTION OF THE PREFERRED EMBODIMENTS

The preferred embodiment of the present invention will be described below in conjunction with the drawings. In the following description, the same or corresponding parts are denoted by the same reference characters. Their names and functions are also the same. Thus, a detailed description thereof will not be repeated.

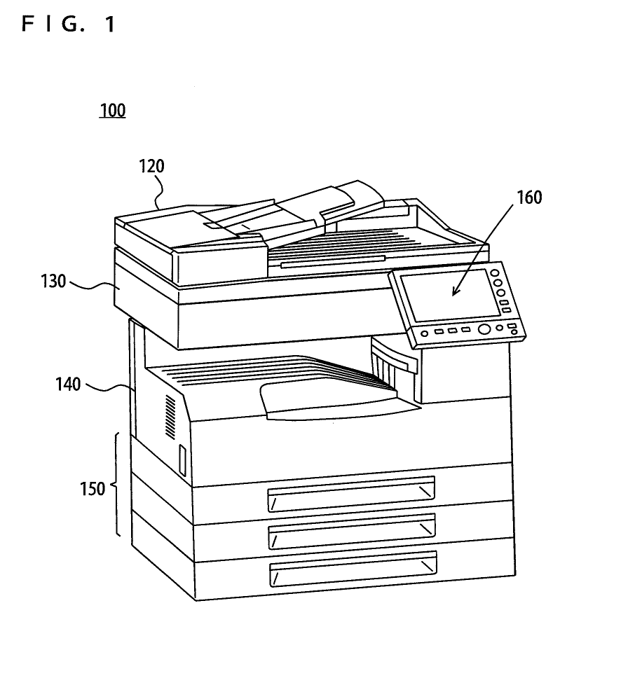

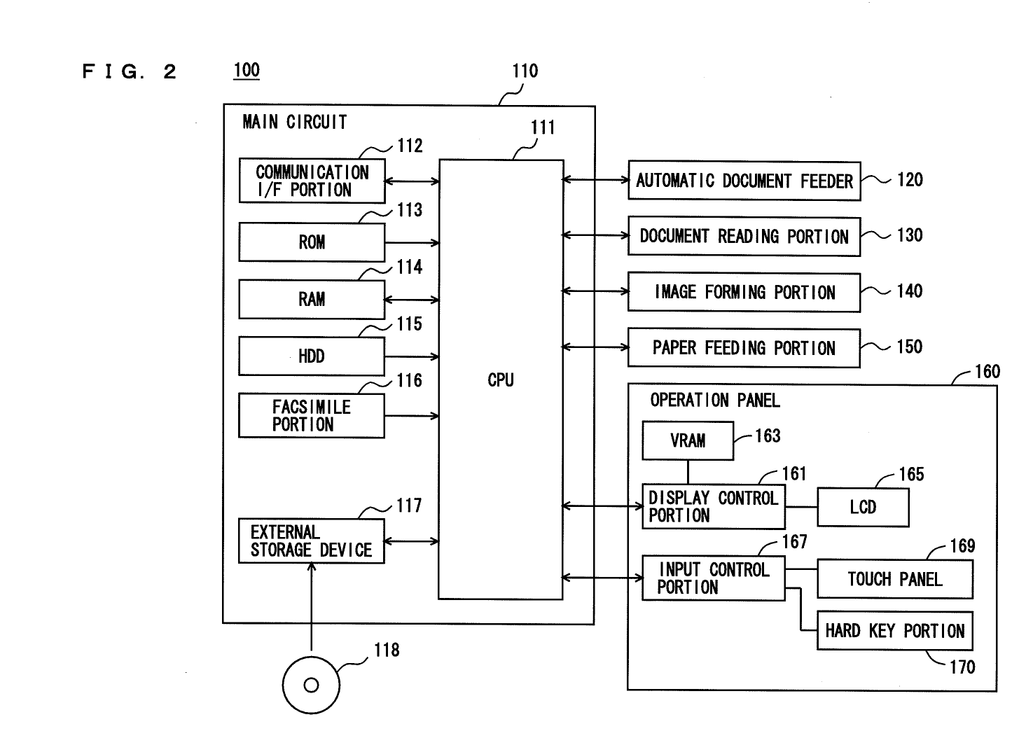

FIG. 1 is a perspective view of an MFP according to an embodiment of the present invention. FIG. 2 is a block diagram schematically showing the hardware configuration of the MFP. Referring to FIGS. 1 and 2, an MFP 100 serving as an image forming apparatus includes: a main circuit 110; a document reading portion 130 for reading a document; an automatic document feeder 120 for feeding a document to document reading portion 130; an image forming portion 140 for forming an image on a sheet of paper or the like on the basis of image data which is output from document reading portion 130 that has read a document; a paper feeding portion 150 for feeding a sheet of paper to image forming portion 140; and an operation panel 160 serving as a user interface.

Main circuit 110 includes: a central processing unit (CPU) 111; a communication interface (I/F) portion 112; a read only memory (ROM) 113; a random access memory (RAM) 114; a hard disk drive (HDD) 115 as a mass storage; a facsimile portion 116; and an external storage device 117. CPU 111 is connected with automatic document feeder 120, document reading portion 130, image forming portion 140, paper feeding portion 150, and operation panel 160, and is responsible for overall control of MFP 100.

Automatic document feeder 120 automatically feeds a plurality of documents set on a document feed tray, one by one, to a predetermined document reading position set on a platen glass of document reading portion 130, and outputs the document, the image of which has been read by document reading portion 130, onto a document output tray. Document reading portion 130 includes an optical source which irradiates a document placed on the document reading position with light and a photoelectric conversion element which receives light reflected from the document, and scans a document image having a size corresponding to that of the document. The photoelectric conversion element converts the received light into image data made up of electric signals, and outputs the image data to image forming portion 140. Paper feeding portion 150 feeds a sheet of paper, stored in a paper feed tray, to image forming portion 140.

Image forming portion 140 forms an image using well-known electrophotography. Image forming portion 140 performs various kinds of data processing such as shading compensation on externally received image data or image data received from document reading portion 130 and, on the basis of the processed image data, forms an image on a sheet of paper fed by paper feeding portion 150.

Facsimile portion 116 is connected to public switched telephone networks (PSTN), and transmits facsimile data to or receives facsimile data from the PSTN. Facsimile portion 116 stores the received facsimile data in HDD 115. Facsimile portion 116 also converts the data into print data which can be printed in image forming portion 140 and outputs the same to image forming portion 140, thereby causing image forming portion 140 to form an image on a sheet of paper on the basis of the facsimile data received by facsimile portion 116. Further, facsimile portion 116 converts the data stored in HDD 115 to facsimile data, and transmits the same to a facsimile machine connected to the PSTN.

Communication I/F portion 112 is an interface for connecting MFP 100 to a network. Communication I/F portion 112 communicates with another computer or image forming apparatus which is connected to the network, using a communication protocol such as the transmission control protocol (TCP) or the file transfer protocol (FTP). The network to which communication I/F portion 112 is connected is a local area network (LAN). It may be connected in a wired or wireless manner. The network is not necessarily the LAN; it may be a wide area network (WAN), public switched telephone networks (PSTN), the Internet, or the like.

ROM 113 stores a program to be executed by CPU 111 or data necessary for execution of the program. RAM 114 is used as a work area when CPU 111 executes a program. Further, RAM 114 temporarily stores data of read images continuously transmitted from document reading portion 130.

Operation panel 160 includes: a liquid crystal display (LCD) 165; a display control portion 161 which controls display on LCD 165; a video RAM (VRAM) 163; a touch panel 169; a hard key portion 170; and an input control portion 167 which controls touch panel 169 and hard key portion 170. LCD 165 and hard key portion 170 are provided on an upper surface of MFP 100.

Display control portion 161 is connected to CPU 111, VRAM 163, and LCD 165. VRAM 163 is used as a work area of display control portion 161, and temporarily stores an image to be displayed on LCD 165. Display control portion 161 controls LCD 165 under the control of CPU 111, to cause LCD 165 to display the image stored in VRAM 163. Display control portion 161 causes LCD 165 to display an operation screen and an input screen, which will be described later.

Hard key portion 170 includes a plurality of hard keys including at least a start key and a keyboard calling key. The hard keys are connected to input control portion 167. Each hard key outputs ON signals to input control portion 167 while being depressed by a user, whereas it outputs OFF signals to input control portion 167 while not being depressed by a user.

Touch panel 169 is provided on an upper or lower surface of LCD 165, and outputs the coordinates of the position pushed by a user to input control portion 167. Touch panel 169 detects a position designated by a user with his/her finger or a stylus pen, and outputs the coordinates of the detected position to input control portion 167. Touch panel 169 preferably has a size equal to or greater than that of the display surface of LCD 165. As touch panel 169 is provided on the surface of LCD 165, when a user designates a position on the display surface of LCD 165, touch panel 169 outputs to input control portion 167 the coordinates of the position that the user has designated on the display surface of LCD 165. The touch panel may be, for example, of a resistive type, a surface acoustic wave type, an infrared ray type, an electromagnetic induction type, or a capacitance type, although it is not limited to these types.

If there is any hard key that outputs ON signals in hard key portion 170, input control portion 167 outputs to CPU 111 identification information for identifying the hard key that outputs the ON signals. In the event that touch panel 169 detects a position designated by a user, input control portion 167 outputs to CPU 111 the coordinates that are output from touch panel 169.

External storage device 117 is controlled by CPU 111, and is mounted with a compact disc-ROM (CD-ROM) 118 or a semiconductor memory.

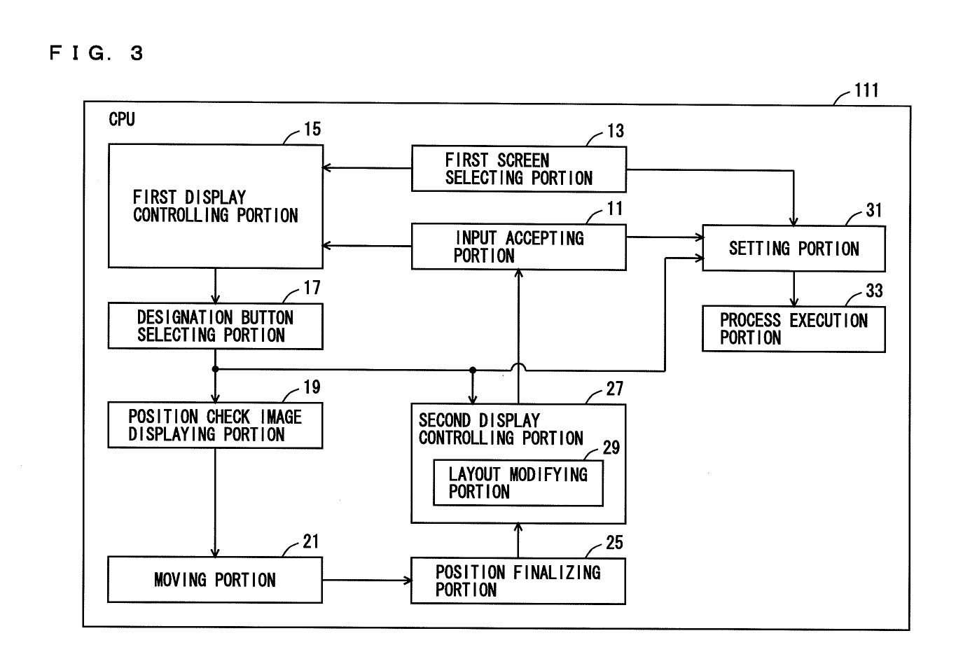

FIG. 3 is a block diagram showing, by way of example, the functions of a CPU included in the MFP. The functions shown in FIG. 3 are formed by CPU 111 included in MFP 100 as CPU 111 executes a program stored in ROM 113, HDD 115, or CD-ROM 118. Referring to FIG. 3, CPU 111 includes an input accepting portion 11, a first screen selecting portion 13, a first display controlling portion 15, a designation button selecting portion 17, a position check image displaying portion 19, a moving portion 21, a position finalizing portion 25, a second display controlling portion 27, a setting portion 31, and a process execution portion 33.

Process execution portion 33 controls communication I/F portion 112, facsimile portion 116, HDD 115, external storage device 117, automatic document feeder 120, document reading portion 130, image forming portion 140, and paper feeding portion 150, to perform processing under the processing conditions set by setting portion 31.

The processing performed by process execution portion 33 includes, for example, scan processing, copy processing, print processing, and facsimile transmission/reception processing. When the setting is made to perform scan processing as one of the processing conditions, process execution portion 33 controls automatic document feeder 120, document reading portion 130, HDD 115, external storage device 117, and communication I/F portion 112, so as to cause an image of a document read by document reading portion 130 to be output to at least one of HDD 115, external storage device 117, and communication I/F portion 112, in accordance with the processing conditions. When the processing condition to set HDD 115 as a destination is set as one of the processing conditions, process execution portion 33 stores the image in HDD 115. When the processing condition to set external storage device 117 as a destination is set as one of the processing conditions, process execution portion 33 stores the image in a semiconductor memory mounted on external storage device 117. When the processing condition to set communication I/F portion 112 as a destination is set as one of the processing conditions, process execution portion 33 transmits the image via communication I/F portion 112. The image may be transmitted by e-mail, or by using the file transfer protocol (FTP), server message block (SMB), or the like. In the case where e-mail is set as the transmission method, e-mail having an image attached thereto is generated for transmission.

When the setting is made to perform copy processing as one of the processing conditions, process execution portion 33 controls automatic document feeder 120, document reading portion 130, paper feeding portion 150, and image forming portion 140, so as to cause image forming portion 140 to form an image of a document read by document reading portion 130 on a sheet of paper supplied from paper feeding portion 150, in accordance with the processing conditions that have been set.

When the setting is made to perform print processing as one of the processing conditions, process execution portion 33 controls communication I/F portion 112, HDD 115, external storage device 117, image forming portion 140, and paper feeding portion 150, so as to cause image forming portion 140 to form an image on a sheet of paper supplied from paper feeding portion 150, in accordance with the processing conditions that have been set. The image to be formed by image forming portion 140 is set by one of the processing conditions. It may be an image of print data that is received from a computer connected to a network via communication I/F portion 112, or an image of data stored in HDD 115 or external storage device 117.

Furthermore, when the setting is made to perform facsimile transmission processing as one of the processing conditions, process execution portion 33 controls automatic document feeder 120, document reading portion 130, HDD 115, external storage device 117, and facsimile portion 116, so as to cause facsimile portion 116 to transmit an image of facsimile data. The facsimile data to be transmitted by facsimile portion 116 is set by one of the processing conditions. It may be an image that document reading portion 130 reads from a document and outputs in accordance with the processing conditions, or an image that is stored in HDD 115 or external storage device 117 and specified by one of the processing conditions.

When the setting is made to perform facsimile reception processing as one of the processing conditions, process execution portion 33 controls facsimile portion 116, HDD 115, external storage device 117, image forming portion 140, and paper feeding portion 150, so as to output an image of facsimile data. When the processing condition to set HDD 115 as a destination is set as one of the processing conditions, process execution portion 33 stores the image of facsimile data in HDD 115. When the processing condition to set external storage device 117 as a destination is set as one of the processing conditions, process execution portion 33 stores the image of facsimile data in a semiconductor memory mounted on external storage device 117. When the processing condition to set communication I/F portion 112 as a destination is set as one of the processing conditions, process execution portion 33 generates e-mail having the image of facsimile data attached thereto, and transmits the e-mail via communication I/F portion 112.

Input accepting portion 11, which is connected with input control portion 167, receives the coordinates of a position that a user has designated on the display surface of LCD 165, or identification information for identifying a hard key that a user has pressed from among a plurality of hard keys included in hard key portion 170.

First screen selecting portion 13 selects one of a plurality of first screens which are stored in HDD 115 in advance, and outputs screen identification information for identifying the selected first screen to first display controlling portion 15 and setting portion 31. Each first screen includes a setting area and a selecting area.

The setting area is used to set a setting value for each of a plurality of setting items which determine the processing conditions for process execution portion 33 to perform the processing. The setting area has an item button (item selecting button) and an area for displaying a setting value, for each of a plurality of setting items. The setting area may have a plurality of item buttons. In this case, the setting area has a plurality of areas for displaying setting values for the plurality of item buttons, respectively. The item buttons are included in designation buttons. Setting screen information includes, for each of the plurality of setting items included in the setting area of the first screen, a set of an item name of the setting item and an attribute of the setting value to be set for the setting item. The attribute includes text or numeric, and in the case of the text, its type and the number of letters, and in the case of the numeric, the number of digits. The selecting area includes a plurality of transition buttons. The transition buttons are included in the designation buttons.

For example, first screen selecting portion 13 displays on LCD 165 a menu screen that includes a plurality of pieces of screen identification information for identifying a plurality of first screens, respectively. When a user operates touch panel 169 or hard key portion 170 to select one of the plurality of pieces of screen identification information displayed on the menu screen, first screen selecting portion 13 selects the first screen corresponding to the selected screen identification information.

When first display controlling portion 15 receives screen identification information from first screen selecting portion 13, first display controlling portion 15 reads from HDD 115 the first screen specified by the screen identification information, and displays the read first screen on LCD 165. More specifically, first display controlling portion 15 outputs the first screen to display control portion 161, to cause display control portion 161 to display the image of the first screen on LCD 165.

When a user selects a designation button included in the first screen displayed on LCD 165, designation button selecting portion 17 selects the selected designation button as a process target. When a user designates one of the plurality of designation buttons displayed on LCD 165 with his/her finger, touch panel 169 detects the position that the user has designated on the display surface of LCD 165. When designation button selecting portion 17 receives from input control portion 167 the position on the display surface of LCD 165 that has been detected by touch panel 169, designation button selecting portion 17 specifies the one of the designation buttons in the first screen designated by the user, on the basis of the received position, and selects the specified designation button as a process target. Designation button selecting portion 17 outputs the button identification information for identifying the designation button that has been selected from among the plurality of designation buttons, to position check image displaying portion 19, second display controlling portion 27, and setting portion 31.

Position check image displaying portion 19 receives button identification information from designation button selecting portion 17. In response to reception of a piece of button identification information, position check image displaying portion 19 displays on LCD 165 a position check image which is identical in shape and size to a second screen that is associated with that piece of button identification information. A table in which pieces of button identification information are associated with second screens is stored in HDD 115 in advance, and position check image displaying portion 19 refers to the table to specify a second screen. Position check image displaying portion 19 displays a position check image on top of the first screen, in the state where the image of the first screen is visible through the position check image that is overlaid thereon. A position check image is an image which, when displayed overlaid on a first screen, allows an image of the first screen to be seen therethrough. Here, the position check image is an image composed solely of an outline of a second screen. Alternatively, the position check image may be a semitransparent image of the second screen.

Position check image displaying portion 19 predetermines a relative relationship between a position in the first screen of the designation button that is specified by the button identification information input from designation button selecting portion 17 and a position of the reference point of the position check image. Then, position check image displaying portion 19 displays the position check image so that the reference point of the position check image is placed on the relative position that is predetermined in relation to the position of the designation button in the first screen. For example, in the case where the relative relationship between the position of the designation button and the display position of the position check image is set to coincide with each other, then the position check image is displayed so that the reference point of the position check image is placed on the same position as the position of the designation button in the first screen. Alternatively, the predetermined relative position may be set such that it is determined in accordance with a position of the designation button in the first screen. For example, the relative position may be set such that, when a designation button is specified, a position check image is displayed on the first screen on a side having a greater area with respect to the position of the specified designation button. More specifically, if a specified designation button is on the right side with respect to the center of the first screen, the position check image may be displayed on the left side with respect to the center of the first screen. Similarly, if a specified designation button is on the upper side with respect to the center of the first screen, the position check image may be displayed on the lower side with respect to the center of the first screen.

Position check image displaying portion 19 outputs to moving portion 21 a position check image and a display position showing the position where the position check image is being displayed on LCD 165. The display position may be represented by the coordinates on the display surface of LCD 165 of a reference point of the position check image. For example in the case of a rectangular position check image, the reference point may be a vertex or the center of the rectangle.

In the case where the designation button specified by the button identification information input from designation button selecting portion 17 is a transition button included in the selecting area in the first screen, a second screen corresponding to the transition button is placed to be in contact with the transition button. Here, a screen in which a transition button and a second screen adjoining thereto are integrated together is called a “balloon window”. Therefore, in the case where the designation button specified by the button identification information input from designation button selecting portion 17 is a transition button included in the selecting area in the first screen, the position check image for the second screen corresponding to the transition button is displayed so as to be in contact with the transition button. It is noted that the position check image may be an image that is identical in shape and size to an image that includes the second screen and the transition button.

Moving portion 21 receives a position check image and its display position from position check image displaying portion 19, and moves the position check image in the setting screen (i.e. the first screen) on the basis of a designation by a user. Moving portion 21 outputs a moved display position of the position check image to position finalizing portion 25. The user's operation in this case is an operation of sliding his/her finger on the display surface of LCD 165. Touch panel 169 outputs a position designated by a user. As a user slides his/her finger on the display surface of LCD 165, touch panel 169 outputs positions that change over time. Therefore, when the user performs the operation of sliding his/her finger on the display surface, touch panel 169 detects a trail of the user's finger slid on the display surface. It is noted that the position output from touch panel 169 is expressed in its coordinates on the display surface of LCD 165.

Touch panel 169 detects positions that change over time. Thus, whenever touch panel 169 detects a different position, moving portion 21 displays the position check image at the position determined in relation to the detected position. A relative relationship between a position detected by touch panel 169 and a position of a reference point of a position check image is predetermined, and the position check image is displayed so that the reference point of the position check image is placed on the position that is determined from the position detected by touch panel 169. At this time, the first screen is being displayed on LCD 165. This allows a user to use his/her finger to designate a position on the first screen, or a position of the position check image on the first screen, while watching the first screen. When the position check image has been moved, moving portion 21 outputs a display position of the moved position check image to position finalizing portion 25.

Position finalizing portion 25 receives from moving portion 21 a position detected by touch panel 169. In the case where the position detected by touch panel 169 is received, when a user's finalizing operation is input, position finalizing portion 25 outputs the position detected by touch panel 169 as a finalized position to second display controlling portion 27. The finalizing operation may include, although not limited thereto, an operation by a user to release his/her finger from touch panel 169. In this case, position finalizing portion 25 detects the finalizing operation when touch panel 169 no longer detects the designation by the user. Alternatively, the finalizing operation may be an operation by a user to stop sliding his/her finger on LCD 165, or, to designate the same position for a predetermined time. In this case, position finalizing portion 25 may be configured to detect that the position detected by touch panel 169 remains unchanged for a predetermined time. It is noted that in the case where a user designates a designation button and performs a finalizing operation without sliding his/her finger, then the position detected by touch panel 169 when the user designated the designation button is detected as a finalized position.

Second display controlling portion 27 receives button identification information from designation button selecting portion 17, and a finalized position from position finalizing portion 25. When second display controlling portion 27 receives the finalized position from position finalizing portion 25, second display controlling portion 27 causes LCD 165 to display the second screen so as to be overlaid on the first screen being displayed on LCD 165. The position for displaying the second screen varies depending on whether the designation button specified by the button identification information input from designation button selecting portion 17 is an item button or a transition button.

In the case where the designation button specified by the button identification information input from designation button selecting portion 17 is an item button, second display controlling portion 27 causes LCD 165 to display the second screen at the finalized position in the first screen being displayed on LCD 165, so as to be overlaid on the first screen. Specifically, second display controlling portion 27 outputs the second screen to display control portion 161, causing display control portion 161 to display the image of the second screen on LCD 165. The image of the second screen is arranged in the first screen such that the reference point of the image of the second screen is placed on the finalized position. As a result, the image of the second screen is displayed in place of the position check image that had been displayed till then.

In the case where the designation button specified by the button identification information input from designation button selecting portion 17 is a transition button, second display controlling portion 27 determines whether the finalized position input from position finalizing portion 25 falls within the selecting area included in the first screen. In the selecting area included in the first screen, a plurality of transition buttons are arranged in a row in a predetermined direction (horizontally in the present embodiment).

Second display controlling portion 27 includes a layout modifying portion 29. When the finalized position input from position finalizing portion 25 falls within the selecting area included in the first screen, second display controlling portion 27 outputs a layout modifying instruction to layout modifying portion 29. Layout modifying portion 29 changes the order of arrangement of a plurality of transition buttons which are arranged in the selecting area included in the first screen. More specifically, layout modifying portion 29 arranges the designation button (transition button) specified by the button identification information input from designation button selecting portion 17 in place of the designation button (transition button) being placed at the finalized position, so that the designation button specified by the button identification information input from designation button selecting portion 17 is placed at a position including the finalized position. Alternatively, layout modifying portion 29 may be configured to switch the positions of the designation button being placed at the finalized position and the designation button specified by the button identification information input from designation button selecting portion 17.

In the case where the finalized position input from position finalizing portion 25 falls within the selecting area included in the first screen, second display controlling portion 27 causes LCD 165 to display the second screen such that it is overlaid on the first screen after the layout of the plurality of transition buttons has been modified by layout modifying portion 29. Second display controlling portion 27 places the second screen in the first screen so that the reference point of the second screen is placed at a position corresponding to the designation button (transition button) specified by the button identification information input from designation button selecting portion 17. Specifically, second display controlling portion 27 outputs the second screen to display control portion 161, to cause display control portion 161 to display an image of the second screen on LCD 165. This causes the image of the second screen to be displayed in place of the position check image that had been displayed till then. In other words, the balloon window having the transition button and the second screen integrated together is moved in parallel.

In the case where the finalized position input from position finalizing portion 25 falls outside the selecting area included in the first screen, second display controlling portion 27 causes LCD 165 to display the second screen at the finalized position in the first screen being displayed on LCD 165, so as to be overlaid on the first screen. Specifically, second display controlling portion 27 outputs the second screen to display control portion 161, to cause display control portion 161 to display an image of the second screen on LCD 165. The image of the second screen is arranged in the first screen such that the reference point of the image of the second screen is placed at the finalized position. This causes the image of the second screen to be displayed in place of the position check image that had been displayed till then.

The second screen includes an input screen. The input screen includes a plurality of input keys. The plurality of input keys are respectively assigned values, which are their key names as well. Second display controlling portion 27 specifies an attribute of a setting value which is paired with the button identification information input from designation button selecting portion 17, and displays only the input keys needed to input a value of the specified attribute. In the case where the attribute of the setting item specified by the item name, i.e. the attribute of the setting value to be set for the setting item, is numeric, second display controlling portion 27 displays only ten input keys to which the numerals 0 to 9 are respectively assigned. In the case where the attribute of the setting item is text, second display controlling portion 27 displays only 26 input keys to which the letters of the alphabet are respectively assigned. The numerals or letters assigned to the input keys become the key names, and the images of the numerals or letters are displayed overlaid on the setting screen. Second display controlling portion 27 outputs the key names for the respective input keys to display control portion 161, to cause display control portion 161 to generate an image by synthesizing the images of the key names of the input keys and the image of the first screen together, while giving higher priority to the images of the key names of the input keys than to the image of the first screen, and further cause display control portion 161 to display the generated image on LCD 165. Second display controlling portion 27 outputs, to input accepting portion 11, a set of a key name and the position on the setting screen at which an image of that key name is displayed, for each of the plurality of input keys.

In the case where the second screen is the input screen, input accepting portion 11 accepts a setting value on the basis of one or more of the plurality of input keys selected by a user in the second screen. When a user designates, with his/her finger, any of the images of the plurality of key names displayed on LCD 165, touch panel 169 detects the position designated by the user. Then, on the basis of the coordinates on the display surface of LCD 165 that have been detected by touch panel 169, input accepting portion 11 specifies which one of the images of the plurality of key names has been designated by the user, and selects the input key that corresponds to the specified key name image. Input accepting portion 11 outputs the value assigned to the selected input key, as a setting value, to setting portion 31. In the case where a plurality of input keys are selected successively, input accepting portion 11 arranges the values assigned respectively to the selected input keys in the selected order to obtain a value, and outputs the obtained value as the setting value to setting portion 31. For example, in the state where the numerals “0” to “9” are assigned respectively to the ten input keys, when the input key to which the numeral “1” is assigned is selected in the first place and the input key to which the numeral “2” is assigned is selected in the second place, then the value “12”, with the second numeral “2” arranged to the right of the first numeral “1”, is determined as the setting value, and the setting value “12” is output to setting portion 31. In the case where the letters of the alphabet are assigned respectively to the 26 input keys, a string of a plurality of letters, arranged in the input order, is output as the setting value to setting portion 31.

Setting portion 31 receives screen identification information from first screen selecting portion 13, button identification information from designation button selecting portion 17, and a setting value from input accepting portion 11. ROM 113 stores, for each piece of screen identification information, default setting values predetermined respectively for a plurality of setting items. When setting portion 31 receives screen identification information from first screen selecting portion 13, setting portion 31 reads the default setting values for the respective setting items that are stored in ROM 113, and stores in RAM 114 a plurality of sets of the default setting values and the item names of the corresponding setting items as processing conditions.

When setting portion 31 receives a setting value from input accepting portion 11, setting portion 31 updates the default setting value stored in RAM 114, with the setting value input from input accepting portion 11. Setting portion 31 updates, with the setting value input from input accepting portion 11, the default setting value that is paired with the item name of the setting item, among those stored in RAM 114, that corresponds to the button identification information input from designation button selecting portion 17 prior to the reception of the setting value from input accepting portion 11. It is noted that the default setting value may be updated provided that a user inputs a setting instruction. The setting instruction is input by a user as the user presses a predetermined hard key.

When the default setting value is updated, setting portion 31 outputs the set of the setting value and the item name of the updated setting item to first display controlling portion 15.

Whenever a setting value is input from input accepting portion 11, setting portion 31 updates the default setting value or a lastly updated setting value stored in RAM 114 as the processing condition, with the input setting value, until an execution instruction is input by the user.

When setting portion 31 receives an execution instruction issued by the user, setting portion 31 outputs an execution command to process execution portion 33. The execution command includes a set of the setting value and the item name of the setting item stored as the processing condition in RAM 114. The execution instruction is issued by a user, for example as the user presses the start key provided on operation panel 160. When setting portion 31 detects the depression of the start key, setting portion 31 determines that the execution instruction has been issued by the user.

Whenever the default setting value or a lastly updated setting value stored in RAM 114 as the processing condition is updated by setting portion 31, they may be output to first display controlling portion 15 to cause it to display the updated setting value. In this case, whenever first display controlling portion 15 receives the set of the setting value and the item name of the setting item from setting portion 31, first display controlling portion 15 updates the setting screen that is being displayed on LCD 165. More specifically, first display controlling portion 15 recomposes a setting screen by arranging the image of the setting value received from setting portion 31 in the area for displaying the setting value corresponding to the setting item on the setting screen, and displays the recomposed setting screen on LCD 165. It is noted, as the input screen is being displayed, an image having the image of the input screen overlaid on the image of the setting screen is displayed on LCD 165 by display control portion 161.

The second screen includes a menu screen for displaying another first screen. In the case where the second screen is the menu screen, input accepting portion 11 accepts one of a plurality of pieces of screen identification information included in the menu screen that is selected by a user. When the user designates, with his/her finger, any of the plurality of pieces of screen identification information displayed on LCD 165, touch panel 169 detects the position designated by the user. Then, on the basis of the coordinates on the display surface of LCD 165 that have been detected by touch panel 169, input accepting portion 11 specifies which one of the plurality of pieces of screen identification information has been designated by the user, and outputs the specified piece of screen identification information to first display controlling portion 15 and setting portion 31.

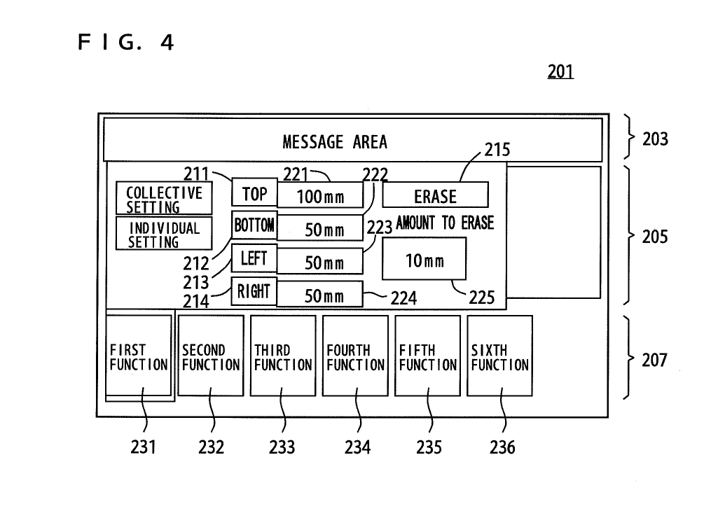

FIG. 4 shows an example of the first screen. Referring to FIG. 4, a first screen 201 includes a message area 203, a setting area 205, and a selecting area 207. Message area 203 displays a message to inform a user, as required. Setting area 205 includes five item buttons 211 to 215 and areas 221 to 225 for displaying setting values for the respective item buttons. Here, default values 100, 50, 50, 50, and 10 are respectively set in areas 221 to 225.

Selecting area 207 includes six transition buttons 231 to 236. Transition buttons 231 to 236 are associated with menu screens corresponding respectively to first to sixth functions.

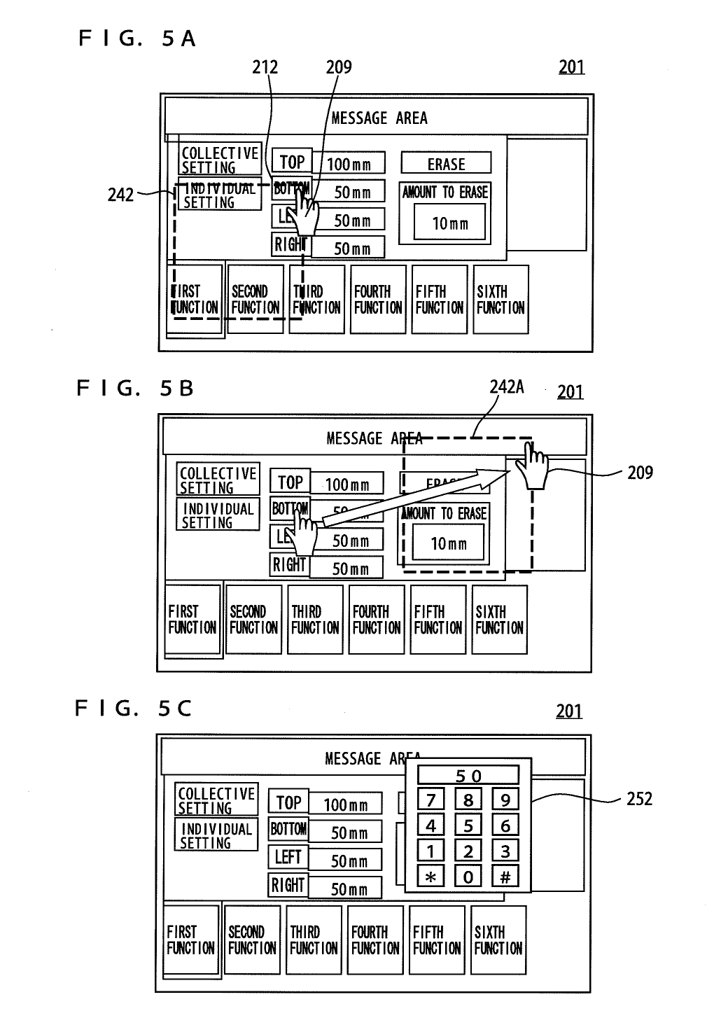

FIGS. 5A to 5C show exemplary displays when an item button is designated. Referring to FIG. 5A, item button 212 in first screen 201 is designated by a finger 209. In this state, a position check image 242 corresponding to item button 212 is displayed. Here, position check image 242 is made up of a broken line as an outline of a second screen that corresponds to item button 212. This allows a user to see the entirety of first screen 201.

FIG. 5B shows, by way of example, the case where the user slides his/her finger on first screen 201 shown in FIG. 5A to a position designated by finger 209. Position check image 242 which has been displayed on first screen 201 in FIG. 5A is moved to the position that is determined by the position of finger 209, and displayed as a position check image 242A.

FIG. 5C shows the state after the user has performed an operation of finalizing the position designated by finger 209 on the first screen. A second screen 252 is displayed, overlaid on first screen 201, in place of position check image 242A that had been displayed in FIG. 5B.

Once second screen 252 is overlaid on first screen 201, a user is unable to see the part of first screen 201 hidden under second screen 252. However, before performing the position finalizing operation, the user is able to check, with the help of position check image 242A, the part of first screen 201 that will be hidden under second screen 252.

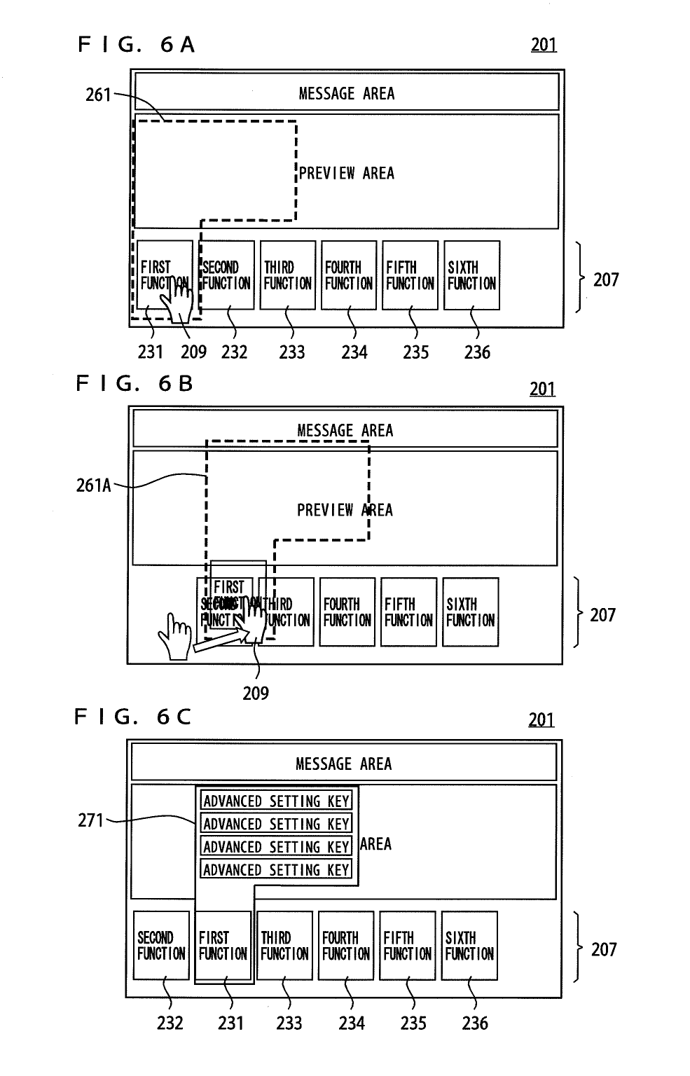

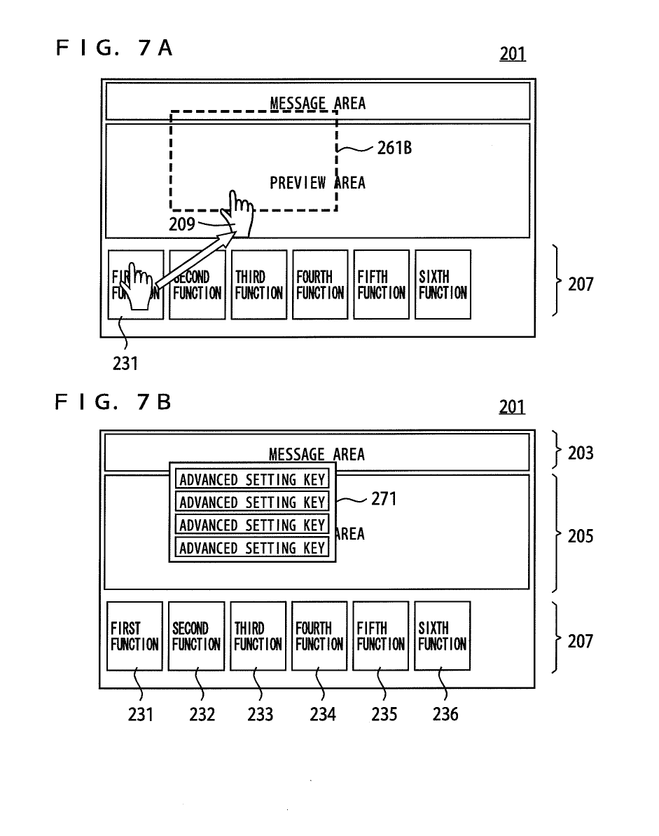

FIGS. 6A to 6C, and FIGS. 7A and 7B show exemplary displays when a transition button is designated. Referring to FIG. 6A, transition button 231 in first screen 201 is designated by a finger 209. In this state, a position check image 261 corresponding to transition button 231 is displayed. Here, position check image 261 is made up of a broken line as an outline of a graphic that includes transition button 231 and a second screen corresponding to transition button 231. This allows a user to see the entirety of first screen 201.

FIG. 6B shows, by way of example, the case where the user slides his/her finger on first screen 201 shown in FIG. 6A to a position designated by finger 209. Finger 209 is positioned within selecting area 207. Position check image 261 which has been displayed on first screen 201 in FIG. 6A is moved to the position that is determined by the position of finger 209, and displayed as a position check image 261A.

FIG. 6C shows the state after the user has performed an operation of finalizing the position designated by finger 209 on the first screen. In selecting area 207, the positions of transition buttons 231 and 232 are changed with each other. Further, a second screen 271 is displayed overlaid on first screen 201. Second screen 271 is arranged in contact with transition button 231. That is, second screen 271 and transition button 231 constitute a balloon window.

Once second screen 271 is overlaid on first screen 201, a user is unable to see the part of first screen 201 hidden under second screen 271. However, before performing the position finalizing operation, the user is able to check, with the help of position check image 261A, the part of first screen 201 that will be hidden under second screen 271.

FIG. 7A shows another case where the user slides his/her finger on first screen 201 shown in FIG. 6A to a position designated by finger 209. Finger 209 is positioned outside selecting area 207 and within setting area 205. Position check image 261 which has been displayed on first screen 201 in FIG. 6A is moved to the position that is determined by the position of finger 209, and displayed as a position check image 261B. Position check image 261B is an image made up of a broken line as an outline of a second screen.

FIG. 7B shows the state after the user has performed an operation of finalizing the position designated by finger 209 on the first screen. In selecting area 207, the positions of transition buttons 231 and 232 remain unchanged. A second screen 271 is displayed overlaid on first screen 201, in place of position check image 261B that had been displayed in FIG. 7A.

Once second screen 271 is overlaid on first screen 201, a user is unable to see the part of first screen 201 hidden under second screen 271. However, before performing the position finalizing operation, the user is able to check, with the help of position check image 261B, the part of first screen 201 that will be hidden under second screen 271.

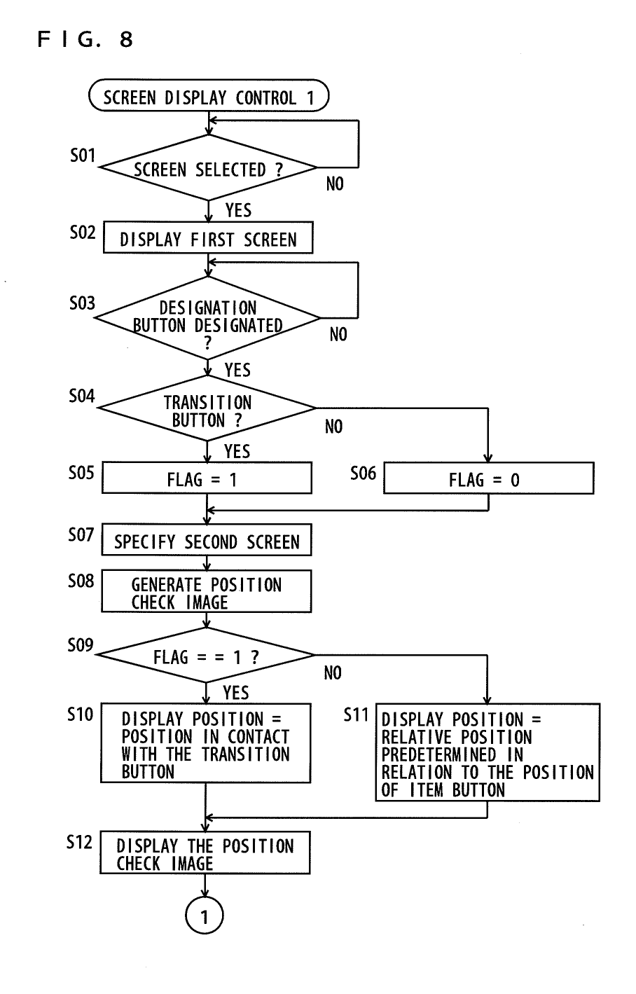

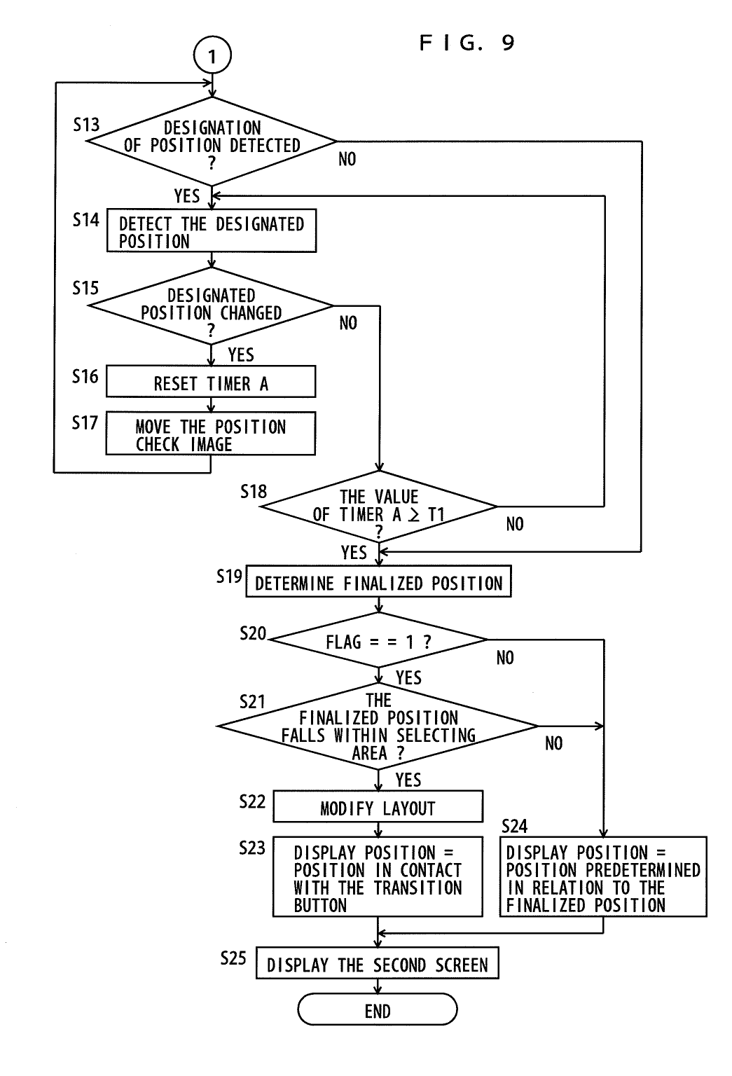

FIGS. 8 and 9 show a flowchart illustrating an example of the flow of a screen display control process. The screen display control process is carried out by CPU 111 included in MFP 100 as CPU 111 executes a program stored in ROM 113, HDD 115, or CD-ROM 118. Referring to FIGS. 8 and 9, CPU 111 determines whether a screen selecting instruction has been accepted (step S01). CPU 111 is in a standby mode until a screen selecting instruction is accepted (“NO” in step S01), and once the screen selecting instruction is accepted (“YES” in step S01), the process proceeds to step S02. CPU 111 displays on LCD 165 a menu screen that includes a plurality of pieces of screen identification information for identifying a plurality of first screens, respectively. When a user operates touch panel 169 or hard key portion 170 to select one of the plurality of pieces of screen identification information displayed on the menu screen, CPU 111 accepts the screen selecting instruction that specifies the selected screen identification information.

In step S02, CPU 111 displays on LCD 165 a first screen that is specified by the screen selecting instruction accepted in step S01. In the following step S03, CPU 111 determines whether one of designation buttons included in the first screen has been designated. CPU 111 is in a standby mode until a designation button is designated (“NO” in step S03), and once the designation button is designated (“YES” in step S03), the process proceeds to step S04. CPU 111 specifies which one of the plurality of designation buttons included in the first screen has been designated, on the basis of the position on the display surface of LCD 165 that is detected by touch panel 169.

In step S04, CPU 111 determines whether the designation button designated in step S03 is a transition button. If so, the process proceeds to step S05; otherwise, the process proceeds to step S06. In step S05, CPU 111 sets a flag to “1”, and then the process proceeds to step S07. On the other hand, in step S06, CPU 111 sets the flag to “0”, and then the process proceeds to step S07. The flag shows whether the designation button designated by a user is a transition button or an item button. It is set to “1” in the case of the transition button and “0” in the case of the item button.

In step S07, CPU 111 specifies a second screen. CPU 111 refers to a table which has been stored in HDD 115 in advance, to specify the second screen that is associated with the designation button designated in step S03. The table has entries which associate pieces of button identification information for identifying designation buttons with pieces of screen identification information for identifying second screens. In the following step S08, CPU 111 generates a position check image. Specifically, CPU 111 generates the position check image on the basis of the second screen specified in step S07. For example, an image made up of a broken line delineating an image that is identical in shape and size to the second screen is generated as the position check image.

In the following step S09, CPU 111 determines whether the flag is set to “1”. In other words, CPU 111 determines whether the designation button designated in step S03 is a transition button. If so, the process proceeds to step S10; otherwise, the process proceeds to step S11.

In step S10, a position at which the position check image is in contact with the transition button is set as a display position, and the process proceeds to step S12. On the other hand, in step S11, a relative position that is predetermined in relation to the position of the item button is set as the display position, and the process proceeds to step S12.

In the following step S12, the position check image generated in step S08 is displayed on LCD 165. The position check image is displayed overlaid on the first screen at the display position set in step S10 or S11. The position check image is an image made up of a broken line delineating the image identical in shape and size to the second screen. Therefore, even if the position check image is displayed overlaid on the first screen, the first screen is visible through the position check image that is overlaid on the first screen.

In step S13, CPU 111 determines whether touch panel 169 is detecting a position designated by the user. If so, the process proceeds to step S14; otherwise, the process proceeds to step S19. That is, after a user designates a designation button, if the user's finger remains in contact with the display surface of LCD 165, the process proceeds to step S14. If the user lifts his/her finger off touch panel 169, the process proceeds to step S19.

In step S14, the position designated by the user is detected as a designated position. CPU 111 then determines whether the designated position has been changed by the user (step S15). If the designated position detected in step S14 is different from the previously detected designated position, CPU 111 detects that the designated position has been changed. If so, the process proceeds to step S16; otherwise, the process proceeds to step S18. In step S16, a timer A is reset, and the process proceeds to step S17. Timer A is for measuring the time during which the same position is designated by the user. When reset, timer A is set to “0” and starts counting up.

In the following step S17, the position check image is moved in the first screen, and the process returns to step S13. Specifically, the position check image is displayed at the display position that is the relative position predetermined in relation to the designated position detected in step S14. In this manner, as the user slides his/her finger on the display surface of LCD 165, the position check image is moved and displayed correspondingly in the first screen.

In step S18, CPU 111 determines whether the value of timer A is a predetermined threshold value T1 or more. In other words, CPU 111 determines whether the time during which the position designated by the user remains unchanged is T1 or more. If time T1 has passed without the user's operation of changing the designated position, the process proceeds to step S19; otherwise, the process returns to step S14.

In step S19, CPU 111 determines a finalized position. The process proceeds to step S19 in the case where the designated position is no longer detected in step S13, or it is detected in step S18 that the user did not change the designated position for the predetermined time T1. In other words, if the user has lifted his/her finger off touch panel 169 after designating a designation button, or if the predetermined time T1 has elapsed while the finger touching touch panel 169 is unmoved, then the process proceeds to step S19. In step S19, the position lastly detected by touch panel 169 is determined as the finalized position, and the process proceeds to step S20.

In step S20, CPU 111 determines whether the flag is set to “1”. In other words, CPU 111 determines whether the designation button designated in step S03 is a transition button. If so, the process proceeds to step S21; otherwise, the process proceeds to step S24.

In step S21, CPU 111 determines whether the finalized position falls within a selecting area. If so, the process proceeds to step S22; otherwise, the process proceeds to step S24. In step S22, the layout of the transition buttons is modified. More specifically, the layout of the plurality of transition buttons included in the selecting area is modified so that the designation button designated in step S03, which is the transition button here, is placed at a position including the finalized position. In the following step S23, the position at which the position check image is in contact with the transition button is set as the display position, and the process proceeds to step S25.

On the other hand, in step S24, the relative position that is predetermined in relation to the finalized position determined in step S19 is set as the display position, and the process proceeds to step S25.

In step S25, the second screen specified in step S07 is displayed at the display position, and the process is terminated. The second screen is displayed in contact with the transition button when the process has proceeded from step S23. The second screen is displayed at a position predetermined from the finalized position when the process has proceeded from step S24.

<Modification>

It has been configured in the above embodiment such that a series of user's operations from when the user touches the display surface of LCD 165 with his/her finger until when the user lifts the finger off the display surface includes an operation of designating a designation button, an operation of moving the position check image, and an operation of displaying the second screen. In a modification, it is configured such that a first operation includes an operation of designating a designation button, and a second operation includes an operation of moving the position check image and an operation of displaying the second screen. Therefore, in the modification, the user's operation of touching the display surface of LCD 165 with his/her finger and then lifting the finger off the display surface is performed twice.

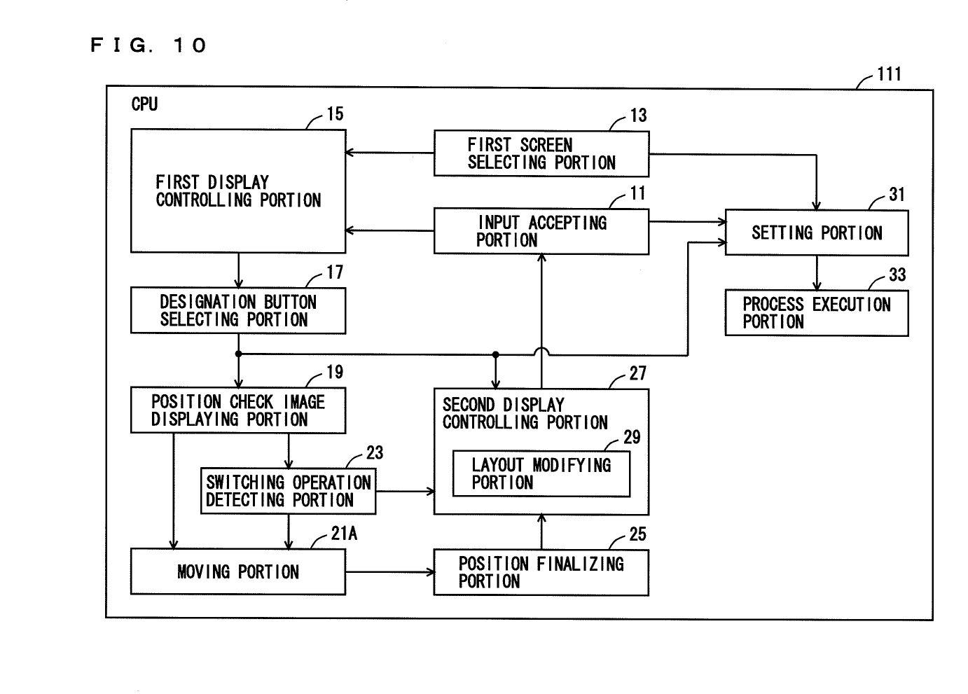

FIG. 10 is a block diagram showing, by way of example, the functions of a CPU included in the MFP according to the modification. Referring to FIG. 10, the functions shown in FIG. 10 differ from the functions shown in FIG. 3 in that a switching operation detecting portion 23 has been added and moving portion 21 has been changed to a moving portion 21A. The other functions are identical to those shown in FIG. 3, and thus, the description thereof will not be repeated here.

Switching operation detecting portion 23 detects a switching operation performed by a user. The switching operation is a user's operation of designating a designation button with his/her finger, lifting the finger off the display surface of LCD 165, and again designating a position on the display surface of LCD 165 with his/her finger. Switching operation detecting portion 23 measures the time that has elapsed from when the position that had been detected by touch panel 169 after selection of the designation button by designation button selecting portion 17 ceased to be detected. After the position that had been detected by touch panel 169 ceased to be detected, when a predetermined time T2 has elapsed with no position detected by touch panel 169, switching operation detecting portion 23 detects a first switching instruction. When switching operation detecting portion 23 detects the first switching instruction, switching operation detecting portion 23 outputs the position that was lastly detected by touch panel 169, as the finalized position, to second display controlling portion 27.

In the event that a position is detected by touch panel 169 before a lapse of the predetermined time T2 from when the position that had been detected by touch panel 169 after selection of the designation button by designation button selecting portion 17 ceased to be detected, switching operation detecting portion 23 detects a second switching instruction.

When switching operation detecting portion 23 detects the second switching instruction, switching operation detecting portion 23 determines whether the position detected by touch panel 169 falls within the position check image or the designation button. If the position detected by touch panel 169 does not fall within the position check image or the designation button, switching operation detecting portion 23 outputs the position detected by touch panel 169, as the finalized position, to second display controlling portion 27. The operation performed by second display controlling portion 27 when it receives the finalized position from switching operation detecting portion 23 is identical to the above-described operation of second display controlling portion 27 when it receives the finalized position from position finalizing portion 25.

If the position detected by touch panel 169 falls within the position check image or the designation button, switching operation detecting portion 23 outputs a moving instruction to moving portion 21A.

When moving portion 21A receives a position check image and its display position from position check image displaying portion 19 and receives a moving instruction from switching operation detecting portion 23, moving portion 21A moves the position check image in the setting screen on the basis of the designation by the user. Moving portion 21A outputs a moved display position of the position check image to position finalizing portion 25. The user's operation in this case is an operation of sliding his/her finger on the display surface of LCD 165. Touch panel 169 outputs a position designated by a user. As a user slides his/her finger on the display surface of LCD 165, touch panel 169 outputs positions that change over time. Therefore, when the user performs the operation of sliding his/her finger on the display surface, touch panel 169 detects a trail of the user's finger slid on the display surface. It is noted that the position output from touch panel 169 is expressed in its coordinates on the display surface of LCD 165.

Touch panel 169 detects positions that change over time. Thus, whenever touch panel 169 detects a different position, moving portion 21A displays the position check image at the position that is determined in relation to the detected position. A relative relationship between a position detected by touch panel 169 and a position of a reference point of a position check image is predetermined, and the position check image is displayed so that the reference point of the position check image is placed at the position that is determined from the position detected by touch panel 169. At this time, the first screen is being displayed on LCD 165, allowing the user to use his/her finger to designate a position on the first screen, or a position of the position check image on the first screen, while watching the first screen. When the position check image is moved, moving portion 21A outputs the display position of the moved position check image to position finalizing portion 25.

The operation performed by position finalizing portion 25 when it receives the display position from moving portion 21A is identical to the above-described operation of position finalizing portion 25 when it receives the display position from moving portion 21.

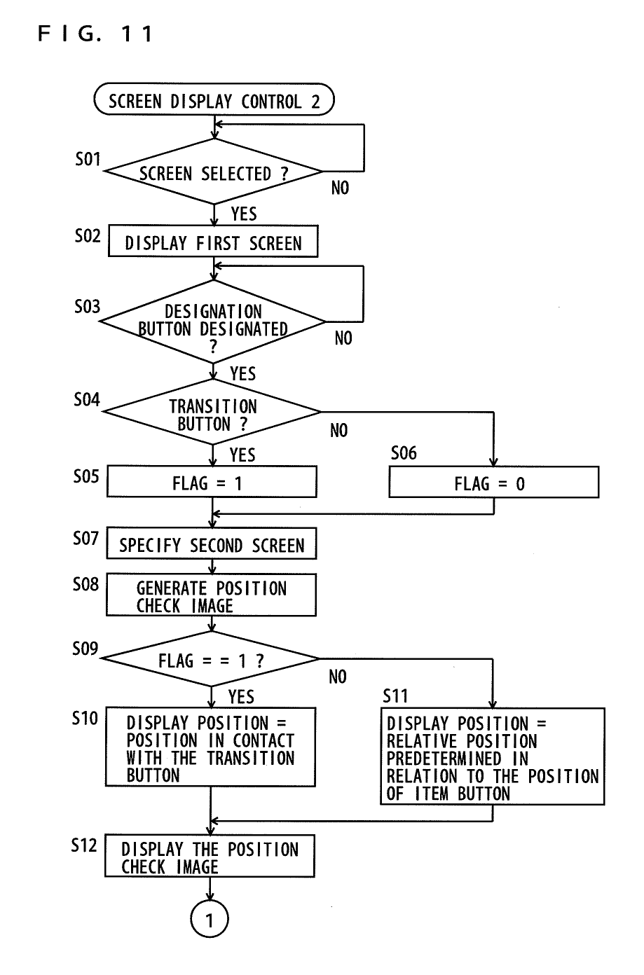

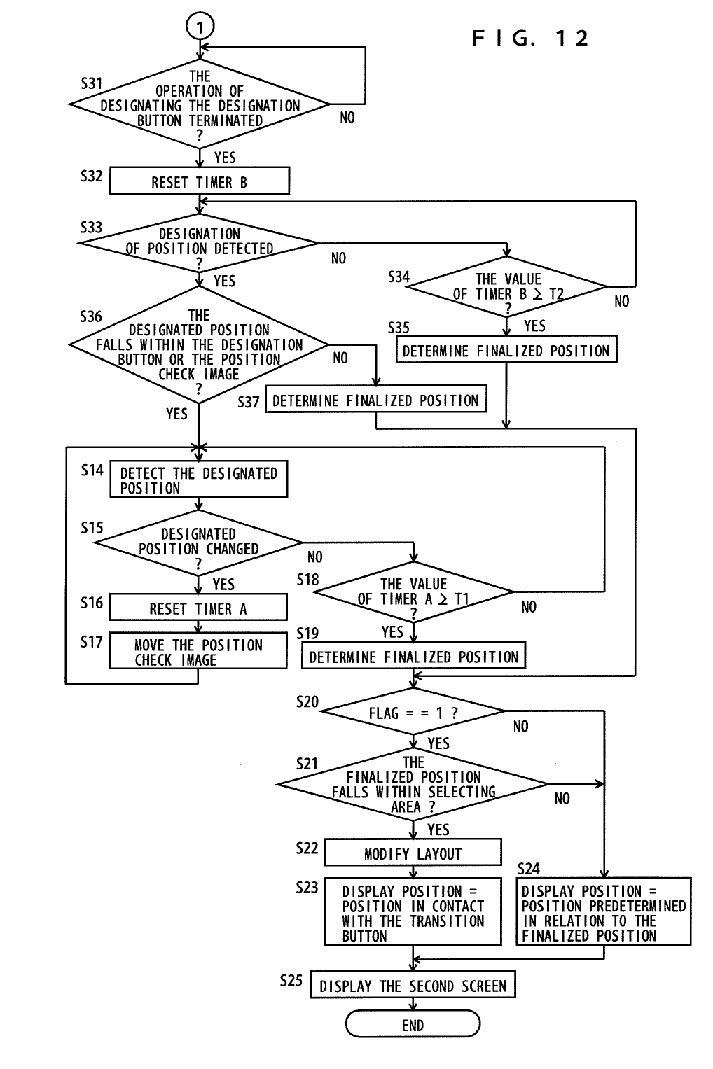

FIGS. 11 and 12 show a flowchart illustrating an example of the flow of the screen display control process according to the modification. The flowchart shown in FIGS. 11 and 12 differs from that shown in FIGS. 8 and 9 in that steps S31 to S37 are performed in place of step S13. The other processing is identical to the processing shown in FIGS. 8 and 9, and thus, the description thereof will not be repeated here.

In step S31, CPU 111 determines whether the operation of designating the designation button, detected in step S03, has been terminated. Specifically, CPU 111 determines whether touch panel 169 is detecting the position continuously. If the position is detected by touch panel 169, CPU 111 determines that the operation of designating the designation button is continued (“NO” in step S31), and enters a standby mode. If touch panel 169 ceases to detect the position, CPU 111 determines that the operation of designating the designation button has been terminated (“YES” in step S31), and the process proceeds to step S32.

In step S32, a timer B is reset. Timer B is for measuring the time that has elapsed from when the user's operation of designating the designation button was terminated. When timer B is reset, timer B is set to “0” and starts counting up.

In step S33, CPU 111 determines whether touch panel 169 has detected a position designated by the user. If so, the process proceeds to step S36; otherwise, the process proceeds to step S34. In step S34, CPU 111 determines whether the value of timer B is a predetermined threshold value T2 or more. In other words, CPU 111 determines whether time T2 or more has elapsed with no position designated by the user since the user had terminated the operation of designating the designation button. If so, the process proceeds to step S35; otherwise, the process returns to step S33. In step S35, the position lastly detected by touch panel 169 is determined as the finalized position, and the process proceeds to step S20.

On the other hand, in step S36, CPU 111 determines whether the designated position falls within the designation button that was designated in step S03 or within the position check image that was displayed in step S12. If the designated position falls within the designation button or the position check image, the process proceeds to step S14; otherwise, the process proceeds to step S37. In step S37, the position lastly detected by touch panel 169 is determined as the finalized position, and the process proceeds to step S20.

As described above, when MFP 100 according to the embodiment of the present invention detects that a position within a designation button in a first screen is designated by a user while the first screen is being displayed, MFP 100 displays a position check image which is identical in shape and size to a second screen that is associated with the designation button in the state where an image of the first screen is visible through the position check image that is overlaid on the first screen. Then, MFP 100 moves the position check image in the first screen, finalizes a position for displaying the second screen in the first screen on the basis of the position of the position check image, and displays the second screen at the finalized position, such that it is overlaid on the first screen. The position for displaying the second screen can be determined in the state where the first screen is visible. This facilitates the operation of determining the position of the second screen that is to be overlaid on the first screen.

Further, when an input screen including a soft keyboard for use in inputting a setting value is to be displayed overlaid on a setting screen for determining processing conditions for MFP 100 to execute copy processing, scan processing, print processing, and facsimile transmission/reception processing, the position of the input screen can be determined in a suitable position. This facilitates the operation of inputting the setting value.

Furthermore, after the position check image is displayed, in response to a change of the position detected by touch panel 169, the position check image is displayed at a position that is determined with reference to the changed position. This allows a user to perform the operations of designating a designation button and moving the position check image as a series of operations, resulting in facilitated operations.

Still further, after the display position of the position check image is changed, when touch panel 169 ceases to detect a position, then the position lastly detected by touch panel 169 is finalized as the position of the second screen. The operation of designating a designation button, the operation of moving the position check image, and the operation of finalizing the position can be performed as a series of operations, resulting in facilitated operations.

While MFP 100 has been described as an example of the image forming apparatus in the above embodiment, the present invention may of course be specified as a display method for causing MFP 100 to perform the screen display control process shown in FIGS. 8 and 9 or FIGS. 11 and 12, or as a display program for causing CPU 111 controlling MFP 100 to perform the display method.

Although the present invention has been described and illustrated in detail, it is clearly understood that the same is by way of illustration and example only and is not to be taken by way of limitation, the spirit and scope of the present invention being limited only by the terms of the appended claims.

### APPENDIX

(1) The image forming apparatus according to claim 5, wherein said switching portion switches the state of said position check image to the movable state in the case where said position detecting portion has detected a position within the same designation button continuously for a predetermined time after said position check image was displayed by said position check image displaying portion.
(2) The image forming apparatus according to claim 5, wherein said switching portion switches the state of said position check image to the movable state in the case where said position detecting portion has detected a position within the same designation button more than once in succession within a predetermined time after said position check image was displayed by said position check image displaying portion.

What is claimed is:

1. An image forming apparatus comprising:
a display portion to display an image;
a position detecting portion to detect a position designated by a user on a display surface of said display portion;
a first display controlling portion to cause said display portion to display a first screen;
a position check image displaying portion operable, in response to detection of a position within a designation button on said first screen by said position detecting portion while said first screen is being displayed, to cause said display portion to display a position check image, the position check image being identical in shape and size to a second screen that is associated with said designation button, the position check image being displayed overlaid on said first screen in the state where an image of said first screen is visible through the position check image overlaid thereon;
a moving portion to move said position check image in said first screen;
a position finalizing portion to finalize a position for displaying said second screen in said first screen, on the basis of the position of said position check image in said first screen; and
a second display controlling portion to cause said display portion to display said second screen at the position in said first screen that is finalized by said position finalizing portion, the second screen being displayed overlaid on said first screen which is being displayed on said display portion.

2. The image forming apparatus according to claim 1, further comprising a process execution portion to execute processing, wherein
said first screen includes a setting screen for setting a setting value for each of a plurality of setting items that determine processing conditions for said process execution portion to execute the processing, and
said designation button includes an item selecting button for selecting one of said plurality of setting items.

3. The image forming apparatus according to claim 1, wherein in response to a change of the position detected by said position detecting portion after said position check image was displayed, said moving portion displays said position check image at a position that is determined in relation to the changed position.

4. The image forming apparatus according to claim 3, wherein in the case where said position detecting portion has ceased to detect a position after the display position of said position check image was changed by said moving portion, said position finalizing portion finalizes the position lastly detected by said position detecting portion as the position for displaying said second screen.

5. The image forming apparatus according to claim 1, wherein
said moving portion includes a switching portion to switch a state of said position check image to a movable state,
said first screen includes a selecting area having a plurality of designation buttons arranged therein,
said second display controlling portion includes a layout modifying portion operable, in the case where the position in said first screen finalized by said position finalizing portion falls within said selecting area, to modify layout of said plurality of designation buttons such that said designation button designated from among said plurality of designation buttons is placed at a position that includes said finalized position, and
in the case where the position in said first screen finalized by said position finalizing portion falls outside said selecting area, said second display controlling portion displays said second screen at a position that is determined in relation to the position finalized by said position finalizing portion, and in the case where the position in said first screen finalized by said position finalizing portion falls within said selecting area, said second display controlling portion displays said second screen at a position that is determined in relation to the position where said designated designation button is placed after the modification of the layout by said layout modifying portion.

6. A display method performed by an image forming apparatus having a display portion to display an image, the method comprising:
a position detecting step of detecting a position designated by a user on a display surface of said display portion;
a first display controlling step of displaying a first screen on said display portion;
a position check image displaying step of, in response to detection of a position within a designation button on said first screen in said position detecting step while said first screen is being displayed, displaying a position check image on said display portion, the position check image being identical in shape and size to a second screen that is associated with said designation button, the position check image being displayed overlaid on said first screen in the state where an image of said first screen is visible through the position check image overlaid thereon;
a moving step of moving said position check image in said first screen;
a position finalizing step of finalizing a position for displaying said second screen in said first screen, on the basis of the position of said position check image in said first screen; and
a second display controlling step of displaying, on said display portion, said second screen at the position in said first screen that is finalized in said position finalizing step, the second screen being displayed overlaid on said first screen which is being displayed on said display portion.

7. The display method according to claim 6, further comprising a process execution step of executing processing, wherein
said first screen includes a setting screen for setting a setting value for each of a plurality of setting items that determine processing conditions for executing the processing in said process execution step, and
said designation button includes an item selecting button for selecting one of said plurality of setting items.

8. The display method according to claim 6, wherein said moving step includes a step of, in response to a change of the position detected in said position detecting step after said position check image was displayed, displaying said position check image at a position that is determined in relation to the changed position.

9. The display method according to claim 8, wherein said position finalizing step includes a step of, in the case where no more position is detected in said position detecting step after the display position of said position check image was changed in said moving step, finalizing the position lastly detected in said position detecting step as the position for displaying said second screen.

10. The display method according to claim 6, wherein
said moving step includes a switching step of switching a state of said position check image to a movable state,
said first screen includes a selecting area having a plurality of designation buttons arranged therein, and
said second display controlling step includes
a layout modifying step of, in the case where the position in said first screen finalized in said position finalizing step falls within said selecting area, modifying layout of said plurality of designation buttons such that said designation button designated from among said plurality of designation buttons is placed at a position that includes said finalized position,
a step of, in the case where the position in said first screen finalized in said position finalizing step falls outside said selecting area, displaying said second screen at a position that is determined in relation to the position finalized in said position finalizing step, and
a step of, in the case where the position in said first screen finalized in said position finalizing step falls within said selecting area, displaying said second screen at a position that is determined in relation to the position where said designated designation button is placed after the modification of the layout in said layout modifying step.

11. A non-transitory computer-readable recording medium encoded with a display program performed by a computer which controls an image forming apparatus, the image forming apparatus having a display portion to display an image,
the program causing said computer to perform:
a position detecting step of detecting a position designated by a user on a display surface of said display portion;
a first display controlling step of displaying a first screen on said display portion;
a position check image displaying step of, in response to detection of a position within a designation button on said first screen in said position detecting step while said first screen is being displayed, displaying a position check image on said display portion, the position check image being identical in shape and size to a second screen that is associated with said designation button, the position check image being displayed overlaid on said first screen in the state where an image of said first screen is visible through the position check image overlaid thereon;
a moving step of moving said position check image in said first screen;
a position finalizing step of finalizing a position for displaying said second screen in said first screen, on the basis of the position of said position check image in said first screen; and
a second display controlling step of displaying, on said display portion, said second screen at the position in said first screen that is finalized in said position finalizing step, the second screen being displayed overlaid on said first screen which is being displayed on said display portion.

12. The non-transitory computer-readable recording medium encoded with the display program according to claim 11, causing said computer to further perform a process execution step of executing processing, wherein
said first screen includes a setting screen for setting a setting value for each of a plurality of setting items that determine processing conditions for executing the processing in said process execution step, and
said designation button includes an item selecting button for selecting one of said plurality of setting items.

13. The non-transitory computer-readable recording medium encoded with the display program according to claim 11, wherein said moving step includes a step of, in response to a change of the position detected in said position detecting step after said position check image was displayed, displaying said position check image at a position that is determined in relation to the changed position.

14. The non-transitory computer-readable recording medium encoded with the display program according to claim 13 wherein said position finalizing step includes a step of, in the case where no more position is detected in said position detecting step after the display position of said position check image was changed in said moving step, finalizing the position lastly detected in said position detecting step as the position for displaying said second screen.

15. The non-transitory computer-readable recording medium encoded with the display program according to claim 11, wherein
said moving step includes a switching step of switching a state of said position check image to a movable state,
said first screen includes a selecting area having a plurality of designation buttons arranged therein, and
said second display controlling step includes
a layout modifying step of, in the case where the position in said first screen finalized in said position finalizing step falls within said selecting area, modifying layout of said plurality of designation buttons such that said designation button designated from among said plurality of designation buttons is placed at a position that includes said finalized position,
a step of, in the case where the position in said first screen finalized in said position finalizing step falls outside said selecting area, displaying said second screen at a position that is determined in relation to the position finalized in said position finalizing step, and
a step of, in the case where the position in said first screen finalized in said position finalizing step falls within said selecting area, displaying said second screen at a position that is determined in relation to the position where said designated designation button is placed after the modification of the layout in said layout modifying step.
